(19) United States
(12) Patent Application Publication
(10) Pub. No.: US 2004/0014495 A1
(43) Pub. Date: Jan. 22, 2004

(54) Method for operating a communications system

(76) Inventor: Ralf Neuhaus, (US)

Correspondence Address: STAAS & HALSEY LLP, SUITE 700, 1201 NEW YORK AVENUE, N.W., WASHINGTON, DC, 20005, US

(21) Appl. No.: 10/380,794

(22) PCT Filed: Sep. 7, 2001
(86) PCT No.: PCT/DE01/03457

(30) Foreign Application Priority Data
Sep. 19, 2000 (DE) 100 46 337.1

(51) Int. Cl. H04M 1/00

(52) U.S. Cl. 455/555; 455/554.1; 455/554.2

(57) ABSTRACT

The invention relates to a method for operating a communications system comprising at least one communications facility and at least one communications terminal. According to said method, a system-specific message (SYS-MSG) that can be displayed on a user interface device (UI) of the communications terminal (TE1, TE2, TE3, MS) and that is sent from the communications facility (PBX) to the communications terminal (TE1, TE2, TE3, MS) is converted according to a protocol for a wireless text and/or graphics transmission and is displayed on the user interface device (UI). When a user inputs a selection (SI), made on the basis of a system-specific message (SYS-MSG) that is displayed on the user interface device (UI), address information (Al) assigned to the input selection (SI) is transmitted to the communications facility (PBX) and is converted into a system-specific message (SYS-MSG) for activating or deactivating a performance characteristic or a service.

With previously known communications terminals connected to a communications facility, only text and/or graphical information predefined and generated by the particular communications facility can be displayed. However, depending on the manufacturer of terminal devices or communications facilities, there are sometimes significant differences in respect of interfaces, protocols and operating principles for displaying text and/or graphical information on terminal devices connected, for example, to a communications facility from a different manufacturer. For this reason the task of making system-specific messages available through a communications facility for terminal devices from any manufacturer has involved considerable overhead in the past. Often, therefore, only a limited number of basic functions can be used uniformly within a communications system. Functions over and beyond the basic functions either cannot be made available uniformly throughout the system at all or can only be made available by means of complicated and not very user-friendly code number procedures.

The object of the present invention is to disclose a method for providing any communications terminals with system-specific messages by means of a communications facility.

This object is achieved according to the invention by a method with the features specified in claim 1. Advantageous developments of the method according to the invention can be gathered from the dependent claims.

A significant aspect of the method according to the invention can be seen in the fact that text and/or graphical information can be made available for supplying any communications terminals with system-specific messages in a communications system according to a standardized protocol. To this end, system-specific messages that are transmitted by a communications facility and are to be displayed on a user interface device of a terminal are converted according to a protocol for wireless text and/or graphical information transmission, for example the known Wireless Access Protocol (WAP). Because of the limited complexity of the protocol, text and/or graphical information formatted accordingly can be converted into virtually any terminal-specific data format or communications facility-specific data transmission protocol. This enables services that are activated or deactivated by means of an exchange of system-specific messages or text and/or graphical information, for example, to be standardized within a communications system.

According to an advantageous embodiment of the method according to the invention, telephone directory entries form part of the text and/or graphical information. The telephone directory entries include, at a minimum, details of the name and call number of a subscriber. In this way a standardized service is made available on a system-wide basis.

The invention is explained in the following by means of exemplary embodiments illustrated in the drawings.

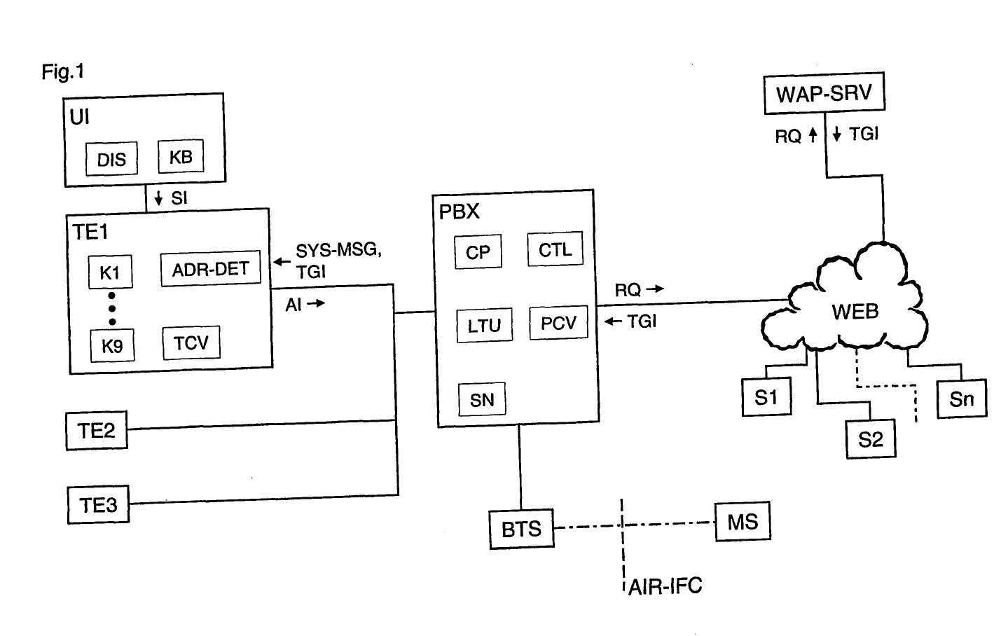

FIG. 1 shows a communications system with a communications facility and a number of terminals, and

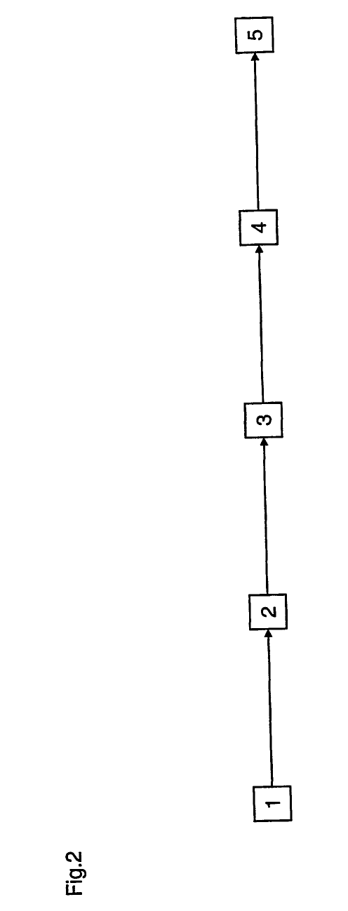

FIG. 2 shows a flow diagram for operation of a communications system.

The communications system shown in FIG. 1 includes a communications facility PBX, a send/receive station BTS, multiple terminals TE1, TE2, TE3 connected to the communications facility PBX, and a mobile terminal MS connected to the send/receive station BTS via a wireless interface AIR-IFC. The communications facility is equipped with a switching network SN, a switching control unit CP and a peripheral connection device.

A system-specific message SYS-MSG to be displayed on a user interface device UI of a communications terminal TE1 is converted by a converter device PCV of the communications facility PBX according to a protocol for wireless text and/or graphical information transmission. This corresponds to step 1 of the flow diagram shown in FIG. 2. The converted system-specific message SYS-MSG is subsequently transmitted from the communications facility PBX to the communications terminal TE1 on whose user interface device UI the system-specific message SYS-MSG is to be displayed (step 2). The user interface device UI features a display device DIS and a keyboard KB. The Wireless Access Protocol (WAP) is used as the protocol for wireless text and/or graphical information transmission.

In the communications terminal TE1, the received system-specific message SYS-MSG is checked to determine whether it can be displayed on the display device DIS in its present format. If the system-specific message SYS-MSG which is formatted according to the Wireless Access Protocol (WAP) cannot be displayed on the display device DIS, the system-specific message SYS-MSG is converted in a converter device TCV of the communications terminal TE1 into a data format which can be displayed by the display device DIS. Finally, the system-specific message SYS-MSG is displayed on the display device DIS with a request for a user input (step 3).

Following a selection input SI by a user based on the system-specific message SYS-MSG, address information AI assigned to the selection input SI is transmitted by the communications terminal TE1 to the communications facility PBX (step 4). There, the address information AI is converted in the converter device PCV into a system-specific message for activation or deactivation of a performance feature or service by, for example, an operating control unit that is not specified in further detail (step 5). The method described can also be carried out in the same manner for the mobile terminal device MS connected to the communications facility PBX via the wireless interface AIR-IFC and the send/receive station. The mobile terminal device MS can be assigned, for example, to an inhouse wireless network that constitutes an extension of an existing inhouse communications network based on one or more communications facilities PBX.

In a request input by a user for text and/or graphical information TGI which is formatted according to the Wireless Access Protocol (WAP), the address information AI is determined in an address value detection device ADR-DET of the communications terminal TE1 on the basis of a selection input SI. The requested text and/or graphical information TGI is identified by the selection input SI. The address information AI is transmitted to the communications facility PBX by the communications terminal TE1.

A connection for packet-oriented data transmission is set up by a control device CTL of the communications facility PBX to a server WAP-SRV which is identified by the address information AI. The control device CTL additionally sends a request RQ for transmission of the text and/or graphical information TGI which is identified by the selection input SI to the server WAP-SRV. The communications facility PBX preferably has an interface—not disclosed in any more detail—to a network WEB for packet-oriented data transmission. An example of such a network WEB is the Internet or an inhouse intranet. Text and/or graphical information requested for a communications device TE1, TE2, TE3 can therefore be retrieved by a plurality of servers S1 to Sn.

The server WAP-SRV sends the text and/or graphical information TGI via the network WEB to the communications facility PBX according to the request RQ. The text and/or graphical information TGI received by the server WAP-SRV is transmitted via the communications facility PBX to the communications terminal TE1 for which the text and/or graphical information TGI was requested. The text and/or graphical information TGI is converted in the converter device TCV of the communications terminal TE1 into the data format that can be displayed by the communications terminal TE1.

Selection information identifying retrievable text and/or graphical information TGI is displayed on the user interface device UI of the communications terminal TE1. Selection information displayed on the communications terminal TE1 can thus be made available for the request input by the user. Alternatively, the request input by the user can be submitted by actuation of a dial key K1 to K9 preprogrammed on the communications terminal TE1.

In an advantageous embodiment of the method according to the invention, a standardized system-wide service can, for example, be made available within a communications system by means of telephone directory entries with, at a minimum, details of name and call number of subscribers as part of the text and/or graphical information. A further service based on the method according to the invention is the sending and receiving of short messages (SMS—Short Message Services) on terminal devices connected to a communications facility. A prerequisite for this is that the particular communications facility offers a means of accessing mobile communications networks.

The application of the invention is not limited to the embodiments described here.

1. Method for operating a communications system comprising a minimum of one communications facility and a minimum of one communications terminal in which
a system-specific message (SYS-MSG) that is to be displayed on a user interface device (UI) of the communications terminal (TE1, TE2, TE3, MS) and that is routed by the communications facility (PBX) to the communications terminal (TE1, TE2, TE3, MS) is converted according to a protocol for a wireless text and/or graphical information transmission and is displayed on the user interface device (UI),
when a user inputs a selection (SI) made on the basis of a system-specific message (SYS-MSG) that is displayed on the user interface device (UI), address information (AI) assigned to the selection input (SI) is transmitted to the communications facility (PBX) and converted into a system-specific message (SYS-MSG) for activating or deactivating a performance feature or service.

2. Method according to claim 1,
characterized in that the system-specific message (SYS-MSG) that is to be displayed on the user interface device (UI) of the communications terminal (TE1, TE2, TE3, MS) is converted by the communications facility (PBX) according to the protocol for wireless text and/or graphical information transmission.

3. Method according to claim 1 or 2,
characterized in that the system-specific message (SYS-MSG) that is to be displayed on the user interface device (UI) of the communications terminal (TE1, TE2, TE3, MS) is converted depending on the ability to display text and/or graphical information formatted according to a predefined protocol on the particular user interface device (UI).

4. Method according to one of the claims 1 to 3, characterized in that
the communications terminal (TE1, TE2, TE3, MS) is connected via a
wireless interface (AIR-IFC) between a send/receive station (BTS) assigned to the communications facility (PBX) and the communications terminal (TE1, TE2, TE3, MS).

5. Method according to one of the claims 1 to 4, characterized in that
the communications terminal (TE1, TE2, TE3, MS) determines address information (AI) in respect of a request input by a user for text and/or graphical information (TGI) formatted according to a protocol for wireless text and graphical information transmission on the basis of a selection input (SI) identifying the requested text and/or graphics information and transmits to a control unit (CTL) assigned to the communications facility (PBX),
the control unit (CTL) sets up a connection for a packet-oriented data transmission to a server (WAP-SRV) identified by the address information (AI) and sends a request (RQ) for the transmission of the text and/or graphical information (TGI) identified by the selection input (SI) to the server (WAP-SRV),
text and/or graphical information (TGI) received by the server (WAP-SRV) is transmitted to the communications terminal (TE1, TE2, TE3, MS) for which the received text and/or graphical information (TGI) was requested.

6. Method according to claim 5,
characterized in that the text and/or graphical information (TGI) transmitted to the communications terminal (TE1, TE2, TE3, MS) is
